(19) United States
(12) Patent Application Publication
(10) Pub. No.: US 2013/0241910 A1
(43) Pub. Date: Sep. 19, 2013

(54) DRIVING CONTROL METHOD AND SOURCE DRIVER THEREOF

(71) Applicant: NOVATEK MICROELETRONICS CORP., Hsin-Chu (TW)

(72) Inventors: Ju-Lin Huang, Hsinchu County (TW); Peng-Yu Chen, Hsinchu City (TW)

(73) Assignee: NOVATEK Microeletronics Corp., Hsin-Chu (TW)

(21) Appl. No.: 13/681,377

(22) Filed: Nov. 19, 2012

(30) Foreign Application Priority Data
Mar. 16, 2012 (TW) 101109101

(51) Int. Cl. G09G 3/36

(52) U.S. Cl. CPC G09G 3/3696
USPC 345/211; 345/87

(57) ABSTRACT

A driving control method for a source driver is disclosed. The driving control method includes outputting a positive display voltage signal to a first output buffer of the source driver and outputting a negative display voltage signal to a second output buffer of the source driver according to a first control signal; and outputting a black-frame voltage signal to the first output buffer and the second output buffer according to a second control signal.

### BACKGROUND OF THE INVENTION

1. Field of the Invention

The present invention relates to a driving control method and source driver thereof, and more particularly, to a driving control method and source driver thereof capable of reducing voltages across relative components without using a charge sharing device.

2. Description of the Prior Art

The advantages of a liquid crystal display (LCD) include light weight, low electrical consumption, and low radiation contamination. LCD monitors have been widely applied to various portable information products, such as notebooks and PDAs. In an LCD monitor, incident light produces different polarization or refraction effects when the alignment of liquid crystal cells is altered. The transmission of the incident light is affected by the liquid crystal molecules, so that a magnitude of the light emitting out of liquid crystal molecules varies. The LCD monitor utilizes the characteristics of the liquid crystal molecules to control the corresponding light transmittance and produce images according to different magnitudes of red, blue, and green light.

If the same polarity voltage (positive voltage or negative voltage) is used to drive liquid crystal cells for a long period of time, the liquid crystal cell will become polarized to a degree that it is not able to recover. The polarization or refraction effects of the liquid crystal cell are thereby decreased and the display quality is also reduced. Therefore, when a source driver of the liquid crystal display drives pixels of the liquid crystal display, the source driver switches the polarity voltages across the liquid crystal cells (i.e. performs polarity inversion) in a certain frequency. In other words, the source driver alternatively uses the positive voltage and the negative voltage for driving the liquid crystal cells.

Please refer to FIG. 1, which is a schematic diagram of a conventional source driver 10. Digital-to-analog converters (DACs) PDAC, NDAC, switches 100-110, output buffers OP1, OP2 and a charge sharing switch SCS are shown in FIG. 1, while components unrelated to the concept of the present invention, such as a timing controller and decoder, are not shown in FIG. 1 for brevity. The digital-to-analog converter PDAC is utilized for receiving a positive pixel data signal SD1 to output a positive display voltage signal VDP. The digital-to-analog converter NDAC is utilized for receiving a negative pixel data signal SD2 to output a negative display voltage signal VDN. The switch 100 is utilized for controlling a connection between the digital-to-analog converter PDAC and a node N1 according to a control signal BFIB. The switch 102 is utilized for controlling a connection between the digital-to-analog converter NDAC and a node N2 according to a control signal BFIB. The digital-to-analog converters PDAC, NDAC are realized by normal-voltage devices, as are the switches 100, 102. The switch 104 is utilized for controlling a connection between the node N1 and an input terminal IN1 of the output buffer OP1 according to a control signal CTL1. The switch 106 is utilized for controlling a connection between the node N1 and an input terminal IN2 of the output buffer OP2 according to a control signal CTL2. The switch 108 is utilized for controlling a connection between the node N2 and the input terminal IN2 according to the control signal CTL1. The switch 110 is utilized for controlling a connection between the node N2 and the input terminal IN1 according to the control signal CTL2. Since the output buffers OP1 and OP2 are realized by high-voltage devices, the switches 104-110 are also realized by high-voltage devices. The output buffer OP1 is utilized for receiving a node voltage VIN1 of the input terminal IN1 to output an output voltage signal VOUT1 to a pixel P1. The output buffer OP2 is utilized for receiving a node voltage VIN 2 of the input terminal IN2 to output an output voltage signal VOUT2 to a pixel P2. The pixel P2 and the pixel P1 are adjacent to each other. The charge sharing switch SCS is utilized for controlling a connection between the input terminal IN1 and the input terminal IN2.

At the beginning of a display period, the switches 100-104 and 108 are conductive and the switches 106, 110 are disconnected, the positive display voltage signal VDP is output to the output buffer OP1, and the negative display voltage signal VDN is output to the output buffer OP2. If the source driver 10 immediately performs the polarity inversion (i.e. the source driver 10 immediately outputs the positive display voltage signal VDP to the output buffer OP2 and outputs the negative display voltage signal VDN to the output buffer OP1), the switches 104, 108 need to be disconnected and the switches 106, 110 need to be conductive. In such a condition, at the moment the switch 106 is conductive, a node voltage VN1 of the node N1 is the negative display voltage signal VDN and the voltage Vswitch1 across the switch 100 becomes the positive display voltage signal VDP minus the negative display voltage signal VDN. The voltage Vswitch1 may be too large and may break the switch 100. Similarly, the voltage Vswitch2 across the switch 102 may break the switch 102. The source driver 10 therefore needs to turn on the charge sharing switch SCS before performing the polarity inversion, so that charge sharing between the input terminal IN1 and the input terminal IN2 can occur, and the voltages Vswitch1, Vswitch2 becoming too large and breaking the switches 100, 102 can be prevented.

Please refer to FIG. 2, which is a timing diagram of related signals when the source driver 10 shown in FIG. 1 is operating. As shown in FIG. 2, a display period instruction signal LD instructs the display period starts at a time T1 and ends at a time T5. Within a range from the time T1 and a time T2, the control signals CTL1, BFIB instruct the conducting status and the control signals CTL2, CTL3 instruct the disconnecting status. The output buffer OP1 receives the positive display voltage signal VDP and the output buffer OP2 receives the negative display voltage signal VDN. In such a condition, if the control signal CTL2 is switched to instruct the conducting status at the time T2, the switches 100, 102 may break. The control signal CTL1 is therefore switched to instruct the disconnecting status and the control signal CTL3 is switched to instruct the conducting status. The charge sharing switch SCS is turned on for performing charge sharing between the input terminal IN1 and the input terminal IN2. Next, the control signal CTL3 is switched to instruct the disconnecting status and the control signal CTL2 is switched to instruct the conducting status. The output buffer OP1 receives the negative display voltage signal VDN and the output buffer OP2 receives the positive display voltage signal VDP. As a result, the source driver 10 completes the polarity inversion.

For preventing the switches 100, 102 from breaking due to the voltages Vswitch1, Vswitch2, the source driver 10 needs to increase the charge sharing switch SCS. This causes the circuit design to become more complex and the manufacturing cost of the integrated circuit will be significantly increased. Therefore, there is a need to improve the prior art.

### SUMMARY OF THE INVENTION

The present invention provides a driving control method and source driver thereof for reducing voltages across internal components when the source driver performs the polarity inversion, thereby preventing the internal components from breaking.

The present invention discloses a driving control method for a source driver. The driving control method comprises outputting a positive display voltage signal to a first output buffer of the source driver and outputting a negative display voltage signal to a second output buffer of the source driver according to a first control signal; and outputting a black-frame voltage signal to the first output buffer and the second output buffer according to a second control signal.

The present invention further discloses a source driver for a display device. The source driver includes a first output buffer, for receiving a positive display voltage signal or a negative display voltage signal at a first input end and accordingly outputting a first source driving voltage signal to a first pixel; a second output buffer, for receiving the positive display voltage signal or the negative display voltage signal at a second input end and accordingly outputting a second driving voltage signal to a second pixel; a positive digital-analog converter, for outputting the positive display voltage signal at a positive output end according to a positive pixel data signal; a negative digital-analog converter, for outputting the negative display voltage signal at a negative output end according to a negative pixel data signal; a positive data switch, coupled to the positive output end and a first node; a negative data switch, coupled to the negative output end and a second node; a positive black-frame switch, coupled to the first node and a black-frame power, wherein the voltage of the black-frame power is a black-frame voltage; a negative black-frame switch, coupled to the second node and the black-frame power; a first flopping switch, coupled to the first node and the first output buffer; a second flopping switch, coupled to the first node and the second output buffer; a third flopping switch, coupled to the second node and the first output buffer; and a fourth flopping switch, coupled to the second node and the second output buffer; wherein the positive data switch, the first flopping switch, the negative data switch and the fourth flopping switch are conducted according to a first control signal, for allowing the positive digital-to-analog converter to output the positive display voltage signal to the first output buffer and allowing the negative digital-to-analog converter to output the negative display voltage signal to the second output buffer; and the positive black-frame switch and the negative black-frame switch are conducted according to a second control signal, for outputting the black-frame voltage signal to the first output buffer and the second output buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional source driver.

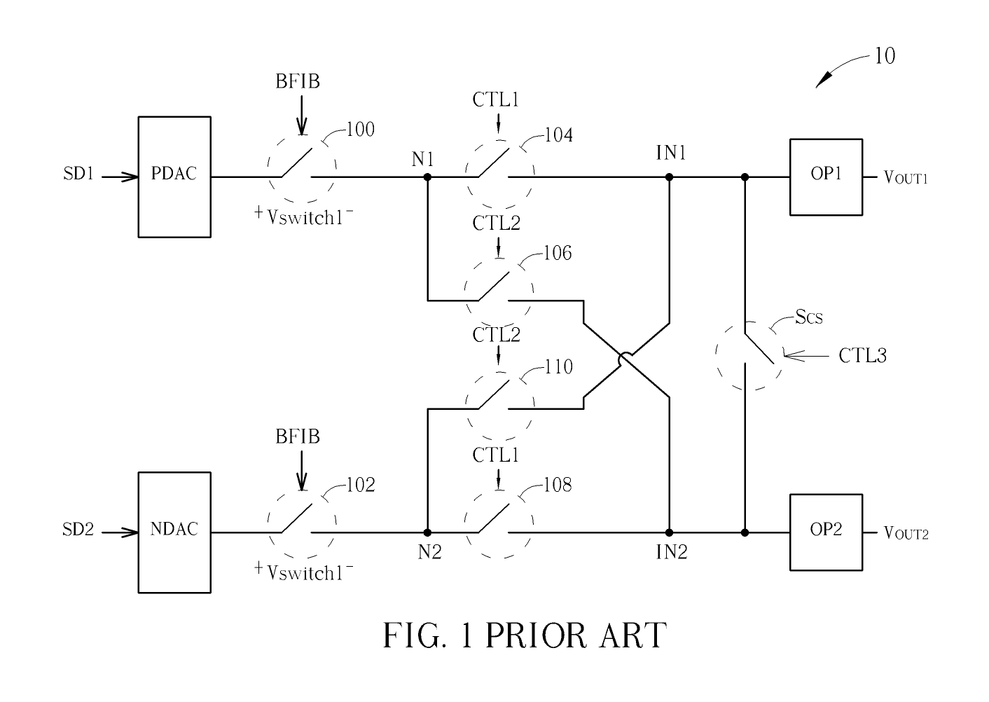

FIG. 2 is a timing diagram of related signals when the source driver shown in FIG. 1 is operating.

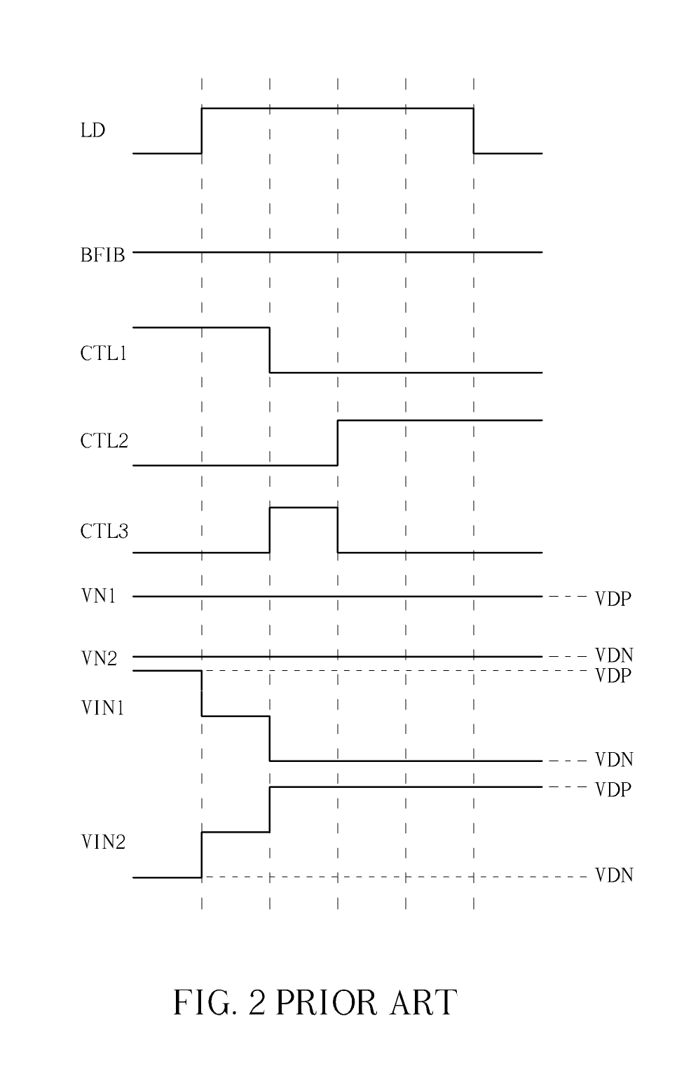

FIG. 3 is a schematic diagram of a source driver according to an embodiment of the present invention.

FIG. 4 is a schematic diagram of related signals when the source driver shown in FIG. 3 is operating.

FIG. 5 is a schematic diagram of another implementation method of the source driver shown in FIG. 3.

FIG. 6 is a schematic diagram of related signals when the source driver shown in FIG. 5 is operating.

FIG. 7 is another schematic diagram of related signals when the source driver shown in FIG. 5 is operating.

FIG. 8 is another schematic diagram of related signals when the source driver shown in FIG. 5 is operating.

FIG. 9 is a flow chart of a driving control method according to an embodiment of the present invention.

### DETAILED DESCRIPTION

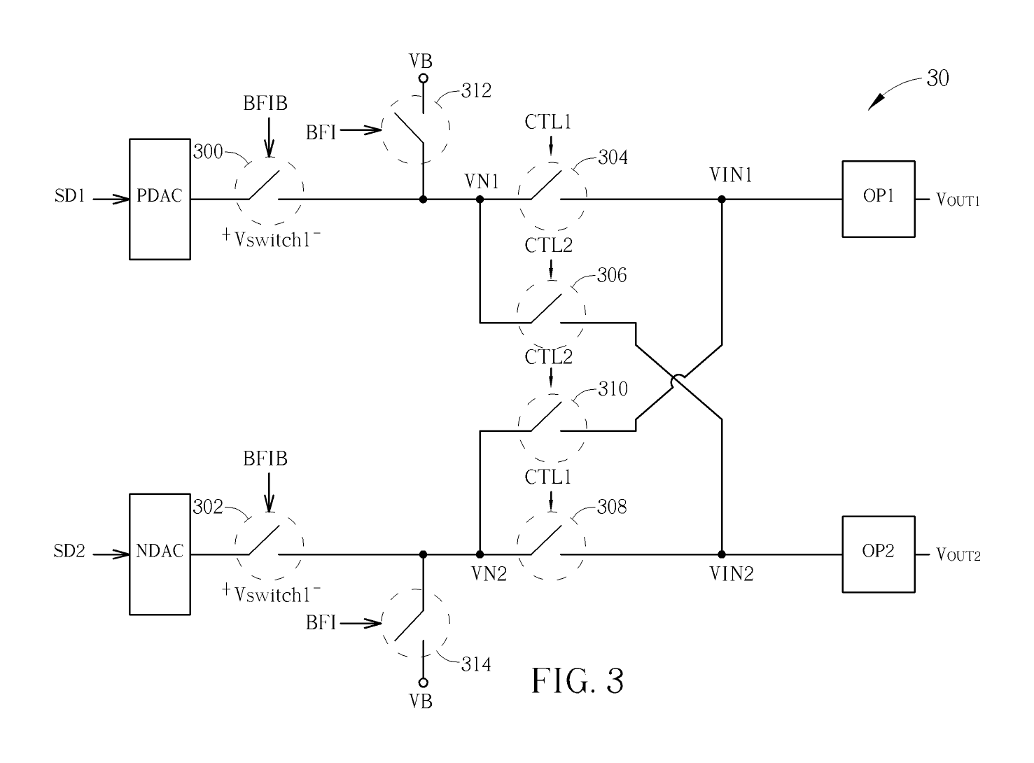

Please refer to FIG. 3, which is a schematic diagram of a source driver 30 according to an embodiment of the present invention. The source driver 30 is utilized for receiving the pixel data signal transmitted by a timing controller and accordingly generating source driving voltage signals VOUT1 and VOUT2 to the pixels P1 and P2 (not shown in FIG. 3). Preferably, the pixel P2 and the pixel P1 are adjacent to each other. As shown in FIG. 3, the source driver 30 comprises digital-to-analog converters PDAC and NDAC, switches 300-310, black-frame switch 312 and 314 and output buffers OP1 and OP2. The digital-to-analog converter PDAC is utilized for transferring a positive pixel data signal SD1 to a positive display voltage signal VDP with positive polarity. The digital-to-analog converter NDAC is utilized for transferring a negative pixel data signal SD2 to a negative display voltage signal VDN with negative polarity. After receiving the pixel data signals transmitted by the timing controller, the source driver 30 splits the pixel data signals into the positive pixel data signal SD1 and the negative pixel data SD2. The positive pixel data signal SD1 and the negative pixel data SD2 are outputted to the digital-to-analog converters PDAC and NDAC, respectively. The operations of splitting the pixel data signal into the positive pixel data signal SD1 and the negative pixel data signal SD2 are well-known to those skilled in the art, and are not described herein for brevity.

The switches 300, 304 are conductive for allowing the digital-to-analog converter PDAC to output the positive display voltage signal VDP with positive polarity to the output buffer OP1, and the switches 302, 308 are conductive for allowing the digital-to-analog converter NDAC to output the negative display voltage signal VDN with negative polarity to the output buffer OP2. When the source driver performs the polarity inversion, the switches 300, 306 are conductive for allowing the digital-to-analog converter PDAC to output the positive display voltage signal VDP to the output buffer OP2, and the switches 302, 310 are conductive for allowing the digital-to-analog converter NDAC to output the negative display voltage signal VDN to the output buffer OP1. The black frame switches 312, 314 are utilized for outputting a black frame voltage signal VB to the output buffers OP1 and OP2, respectively, according to the control signal BFI. In the present invention, for achieving the black frame insertion, the black frame switches 312, 314 can make the pixels P1 and P2 display black frame data within two picture frames or adjust the voltages of the nodes N1, N2 and the input terminals IN1, IN2 to the black frame voltage signal VB before performing the polarity inversion. The voltage of the black frame voltage signal VB is within a range from the greatest voltage of the positive display voltage signal VDP to the lowest voltage of the negative display voltage signal VDN. For example, the voltage of the black frame voltage signal VB is an average of the greatest voltage and the lowest voltage of the source driver 30.

The source driver 30 conducts the black frame switches 312, 314 before the source driver 30 performs the polarity inversion via adjusting the timing sequences of the control signals BFI, BFIB, CTL1, CTL2, for adjusting the voltages of the nodes N1, N2 and the input terminals IN1, IN2 to the voltage of the black frame signal VB. Since both the voltage difference between the black frame voltage signal VB and the positive display signal VDP and the voltage difference between the black frame voltage signal VB and the negative display voltage signal VDN are smaller than the voltage difference between the positive display voltage signal VDP and the negative display voltage signal VDN, the voltage swings of the nodes N1, N2 and the input terminals IN1, IN2 are efficiently decreased, meaning the switches 300 and 302 will not be broken due to over-large voltage crossing them.

In the beginning of a frame display period, the switches 300, 302, 304, 308 are conductive and the black frame switches 312 and 314 are disconnected according to the control signals BFI, BFIB, CTL1, CTL2, such that a node voltage VN1 of the node N1 and a node voltage VIN1 of the input terminal VIN1 equal the voltage of the positive display voltage signal VDP and a node voltage VN2 of the node N2 and a node voltage VIN2 of the input terminal VIN2 equal the voltage of the negative display voltage signal VDN. Since the switches 300, 302, 304, 308 are conductive, the output buffer OP1 receives the positive display voltage signal VDP outputted by the digital-to-analog converter PDAC and the output buffer OP2 receives the negative display voltage signal VDN outputted by the digital-to-analog converter NDAC. Then, the switches 300-310 are disconnected and the black frame switches 312, 314 are conductive, such that the node voltages VN1, VN2 become the voltage of the black frame voltage signal VB. Next, the switches 306, 310 are conductive and the switches 300-304, 308 are still disconnected, such that the node voltages VIN1, VIN2 become the voltage of the black frame voltage signal VB. In such a condition, the output buffers OP1, OP2 receive the black frame voltage signal VB, respectively. After the node voltages VN1, VN2, VIN1, VIN2 become the voltage of the black frame voltage VB, the source driver 30 performs the polarity inversion. The switches 304, 308 and the black frame switches 312, 314 are disconnected and the switches 300, 302, 306, 310 are conductive, such that the node voltages VN1, VIN2 equal the voltage of the positive display voltage signal VDP and the node voltages VN2, VIN1 equal the voltage of the negative display voltage signal VDN, for achieving the polarity inversion. In such a condition, the output buffer OP1 receives the negative display voltage signal VDN outputted by the digital-to-analog converter NDAC and the output buffer OP2 receives the positive display voltage signal VDP outputted by the digital-to-analog converter PDAC. Finally, before the display period ends, the switches 300-304 and 308 are disconnected and the switches 306, 310 and the black frame switches 312, 314 are conductive, such that the node voltages VN1, VN2, VIN1, VIN2 return to the voltage of the black frame voltage VB, for allowing the output buffers OP1, OP2 to output the black frame voltage signal VB. The pixels P1 and P2 accordingly display black frame data for performing the black frame insertion.

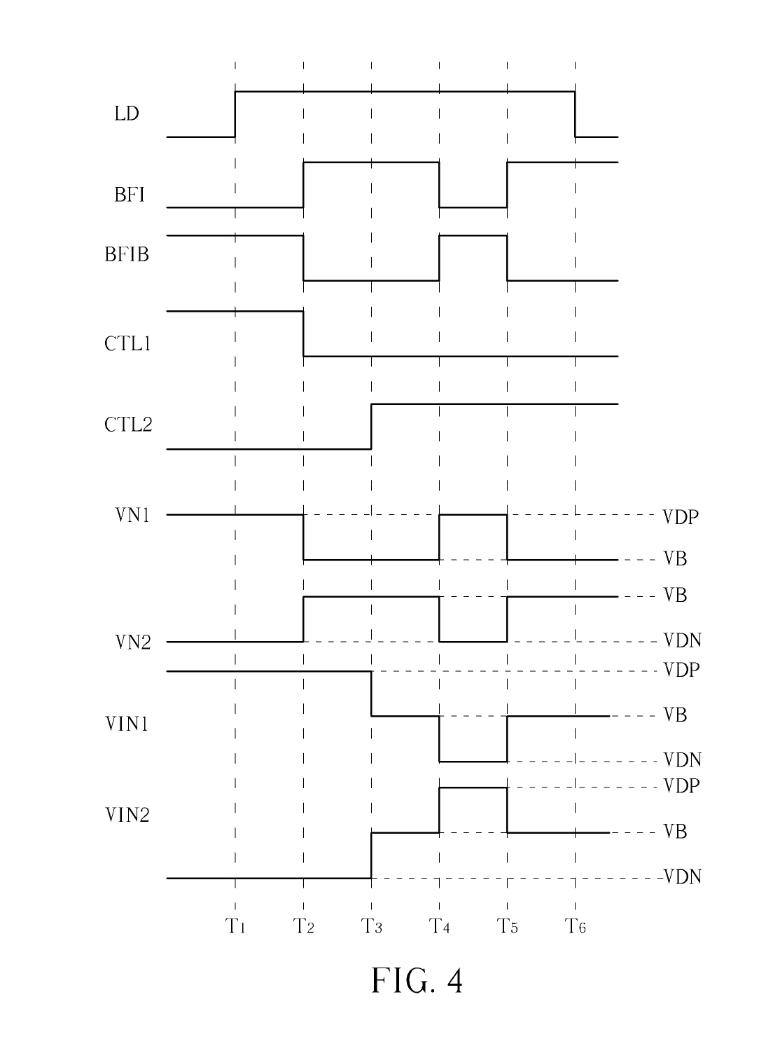

Please refer to FIG. 4, which is a timing diagram of related signals when the source driver 30 shown in FIG. 3 is operating. As shown in FIG. 4, it is assumed that a display period instruction signal LD is utilized for instructing frame display periods, i.e. the display period instruction signal LD is at the high logic level from a time T1 to a time T6 for instructing a frame display period. Between the time T1 and time T2, the control signals BFIB, CTL1 instruct the conducting status and the control signals BFI, CTL2 instruct the disconnecting status. The node voltages VN1, VIN1 equal the voltage of the positive display voltage signal VDP and the node voltages VN2, VIN2 equal the voltage of the negative display voltage signal VDN. At time T2, the control signals BFIB, CTL1 are switched to instruct a disconnected status, and therefore the node voltages VN1, VN2 become the voltage of the black frame voltage signal VB. At the time T3, the control signal CTL2 is switched to instruct the conducting status, and therefore the node voltages VIN1, VIN2 equal the voltage of the black frame voltage signal VB. At time T4, the control signal BFI is switched to instruct the disconnected status and the control signal BFIB is switched to instruct the conducting status, and thus the node voltage VIN1 becomes the voltage of negative display voltage signal VDN and the node voltage VIN2 becomes the voltage of the positive display voltage signal VDP. Finally, at time T5, the control signal BFIB is switched to instruct the disconnected status and the control signal BFI is switched to instruct the conducting status, and thus the node voltages VN1, VN2, VIN1, VIN2 become the voltage of the black frame voltage signal VB.

Note that, for adjusting the node voltages VIN1, VIN2 to the voltage of the black frame voltage signal VB, the control signals BFIB, CTL1 are switched to instruct the disconnected status first, and then the control signal CTL2 is switched to instruct the conducting status as shown in FIG. 4. In addition, the control signals BFIB, CTL1, CTL2 can be switched at the same time, for adjusting the node voltages VIN1, VIN2 to the voltage of the black frame voltage signal VB.

The black frame insertion procedure is performed between each frame display period. In other words, the black frame insertion procedure is performed before the start of a next frame display period (for example, the time T5 shown in FIG. 4), so as to increase fluency of the dynamic images. Before performing the polarity inversion in a frame display period, the source driver 30 of the present invention outputs the black frame voltage signal VB to the nodes N1, N2 and the input terminals IN1, IN2 by utilizing the black frame insertion structure and adjusting the timing sequence of the control signals. The voltages of the nodes N1, N2, IN1, IN2 become the voltage of the black frame voltage signal VB. As a result, when the source driver 30 performs the polarity inversion, the voltage swings of the nodes N1, N2, IN1, IN2 can be effectively decreased, which prevents the switches 300, 302 from breaking.

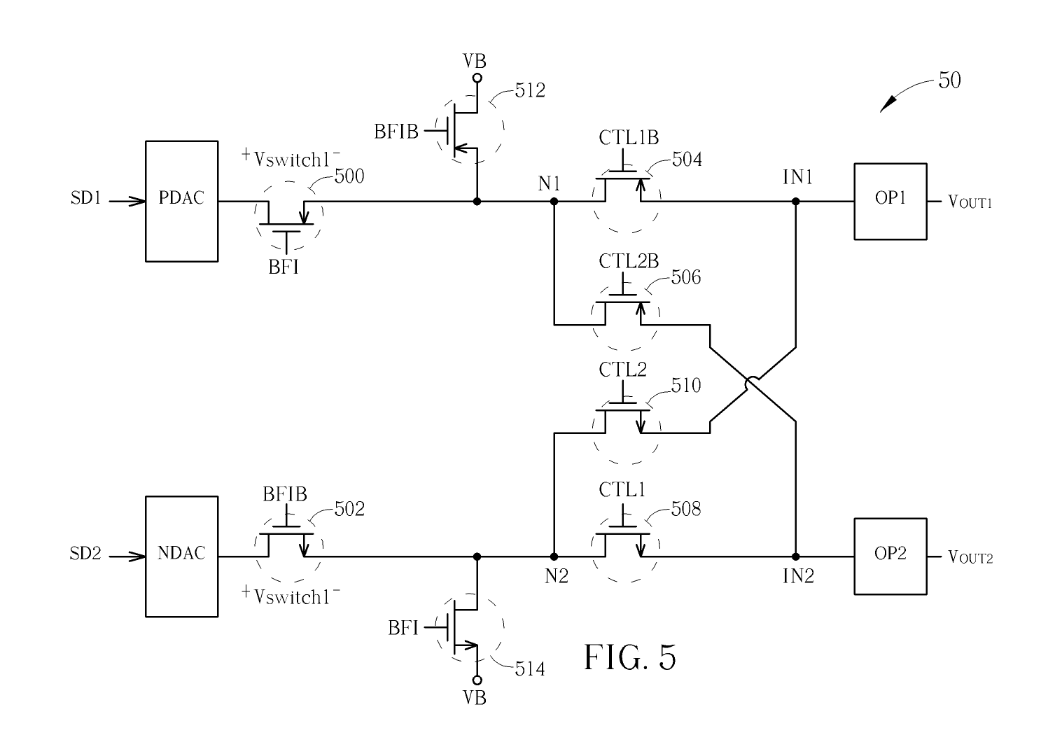

Please refer to FIG. 5, which is a schematic diagram of a source driver 50 according to an embodiment of the present invention. The source driver 50 is an implantation method of the source driver 30 shown in FIG. 3. Compared with the source driver 30 shown in FIG. 3, the switches 300-310 and the black frame switches 312, 314 are realized by transistors 500-514 in FIG. 5. As shown in FIG. 5, the transistors 500, 504, 506, 512 are PMOSs and the transistors 502, 508, 510, 514 are NMOSs. For achieving the same conducting sequence of the switches 300-310 and the black frame switches 312, 314 shown in FIG. 3, the configurations of the control signals in the source driver 50 are accordingly adjusted. The transistors, 500, 514 are controlled by the control signal BFI and the transistors 502, 512 are controlled by the control signal BFIB. The transistors 504-510 are respectively controlled by the control signals CTL1B, CTL2B, CTL1, CTL2. As a result, the operation methods of the source driver 50 can be known by referring to the above paragraphs, and are therefore not described herein.

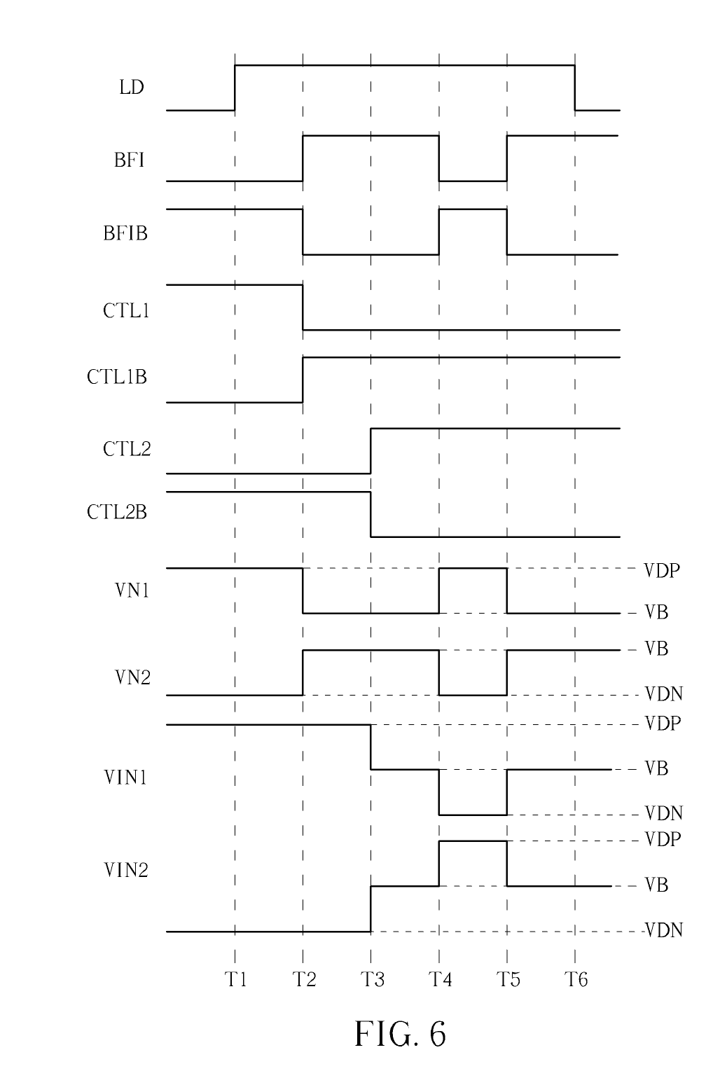

Please refer to FIG. 6, which is a timing diagram of related signals when the source driver 50 shown in FIG. 5 is operating. As shown in FIG. 6, the display period instruction signal LD is at the high logic level for instructing the frame display period. Between time T1 and time T2, the control signals BFIB, CTL1, CTL2B are at the high logic level and the control signals BFI, CTL1B, CTL2 are at the low logic level. At this point, the transistors 500-504, 508 are conductive, and therefore the node voltages VN1, VIN1 equal the voltage of the positive display voltage signal VDP and the node voltages VN2, VIN2 equal the voltage of the negative display voltage signal VDN. At time T2, the control signals BFIB, CTL1 are switched to the low logic level and the control signals BF1, CTL1B are switched to the high logic level, such that the transistors 512, 514 are conductive and the transistors 500-504, 508 are disconnected. In such a condition, the node voltages VN1, VN2 equal the voltage of the black frame voltage signal VB. At time T3, the control signal CTL2 increases to the high logic level and the control signal CTL2B decreases to the low logic level. In such a condition, the transistors 506, 510 are conductive and node voltages VIN1, VIN2 become the voltage of the black frame voltage signal VB. At time T4, the control signal BFI decreases to the low logic level and the control signal BFIB increases to the high logic level, such that the transistors 500, 502 are conductive and the transistors 512, 514 are disconnected. The node voltage VIN1 becomes the voltage of the negative display voltage signal VDN and the node voltage VIN2 becomes the voltage of the positive display voltage signal VDP. Finally, at time T5, the control signal BFI increases to the high logic level and the control signal BFIB decreases to the low logic level. The node voltages VIN1, VIN2 back to the voltage of the black frame voltage signal VB, for realizing the black frame insertion when the frame display period is switching.

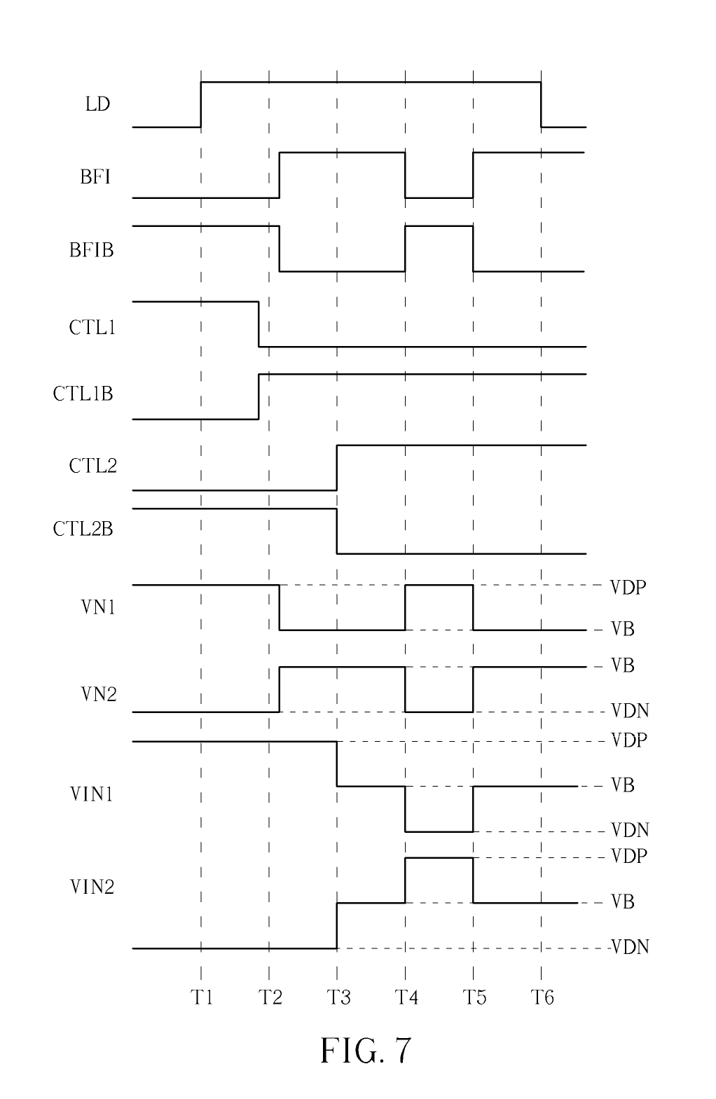

The spirit of the present invention is directed to adjusting the timing sequences of the control signal for realizing the black frame insertion, which reduces the voltages crossing the switches in the source driver, and can thereby prevent their breakage. Those skilled in the art can accordingly observe appropriate modifications and alternations. For another illustration of the invention's application, please refer to FIG. 7, which is another timing diagram of related signals when the source driver 50 shown in FIG. 5 is operating. As shown in FIG. 7, the control signals BF1, CTL1 and the control signals BF1B, CTL1B are non-overlapping signals, so as to prevent charge sharing from occurring in the source driver 50 which may result in the source driver 50 operating abnormally.

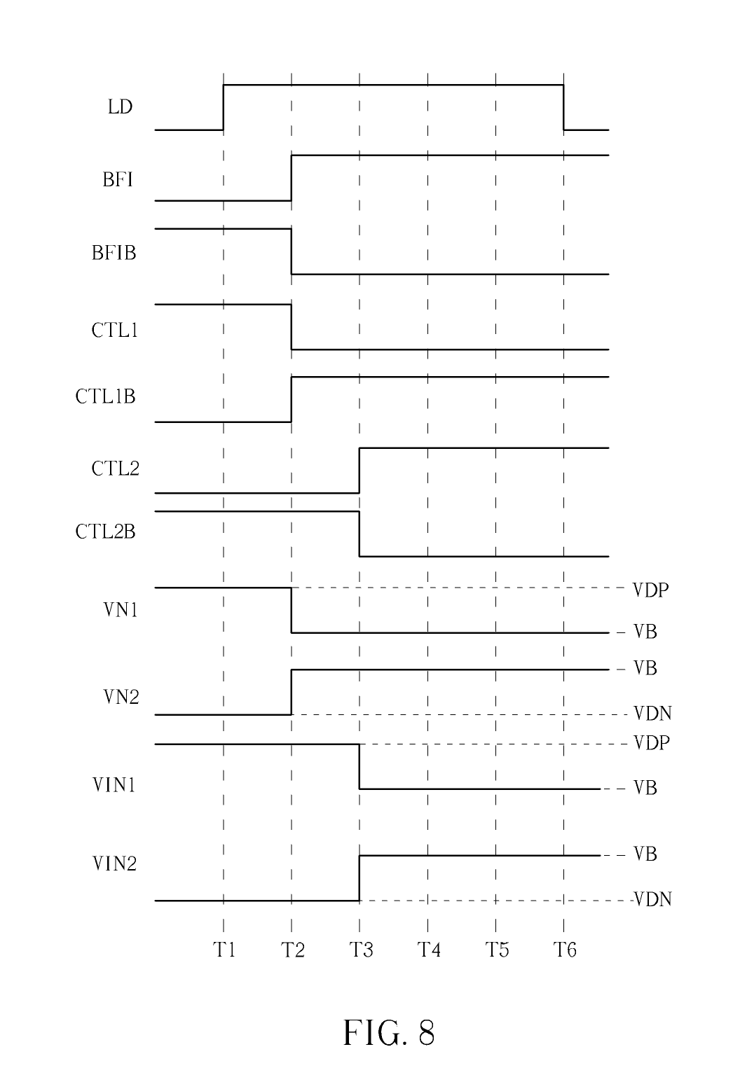

Please refer to FIG. 8, which is another timing diagram of related signals when the source driver 50 shown in FIG. 5 is operating. As shown in FIG. 8, the control signal BFI maintains the high logic level and the control signal BFIB maintains the low logic level after the time T2. In such a condition, the node voltages VN1, VN2 maintain the voltage of the black frame voltage signal VB till time T6. Therefore, the node voltages VIN1, VIN2 also maintain the voltage of the black frame voltage signal VB after the time T3. Before the period instruction signal LD decreases to the low logic level (i.e. before the frame display period ends), as long as the node voltages VIN1, VIN2 are switched to the voltage of the black frame voltage signals, the output buffers OP1, OP2 will output the black frame voltage signal VB to the pixels P1, P2. In such a condition, the source driver 50 does not perform the polarity inversion.

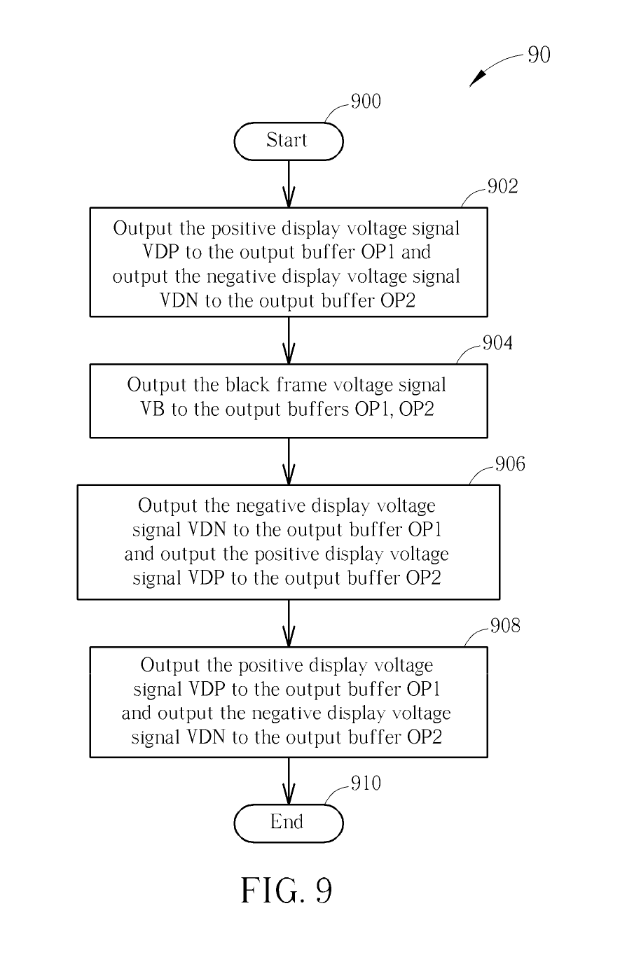

The operation methods of the source driver 30 can be summarized by a driving control method 90. Please refer to FIG. 9, which is a schematic diagram of the driving control method 90 according to an embodiment of the present invention. As shown in FIG. 9, the driving control method 90 comprises the following steps:

Step 900: Start.

Step 902: Output the positive display voltage signal VDP to the output buffer OP1 and output the negative display voltage signal VDN to the output buffer OP2.

Step 904: Output the black frame voltage signal VB to the output buffers OP1, OP2.

Step 906: Output the negative display voltage signal VDN to the output buffer OP1 and output the positive display voltage signal VDP to the output buffer OP2.

Step 908: Output the positive display voltage signal VDP to the output buffer OP1 and output the negative display voltage signal VDN to the output buffer OP2.

Step 910: End.

The detailed operation methods of the driving control method 90 can be known by referring to the above paragraphs, and are therefore not described herein.

In summary, the present invention realizes a function similar to the charge sharing switch by adjusting timing sequences of the control signals and the circuit components utilized therein to realize black frame insertion. In comparison with the prior art, the present invention does not require the charge sharing switch. Furthermore, the present invention utilizes the circuit components for realizing the black frame insertion to effectively reduce the complexity of the circuit design and to significantly decrease the manufacturing cost of the integrated circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving control method for a source driver, comprising:
outputting a positive display voltage signal to a first output buffer of the source driver and outputting a negative display voltage signal to a second output buffer of the source driver according to a first control signal; and
outputting a black-frame voltage signal to the first output buffer and the second output buffer according to a second control signal.

2. The driving control method of claim 1, further comprising:
after outputting the black-frame voltage signal to the first output buffer and the second output buffer, outputting the positive display voltage signal to the second output buffer and outputting the negative display voltage signal to the first output buffer according to a third control signal; and
outputting the black-frame voltage signal to the first output buffer and the second output buffer according to a fourth control signal.

3. The driving control method of claim 1, wherein the first output buffer outputs a first source driving voltage signal to a first pixel, the second output buffer outputs a second source driving voltage signal to a second pixel, and the first pixel and the second pixel are adjacent.

4. The driving control method of claim 1, wherein the voltage of the black-frame voltage signal is within a range from the greatest voltage of the positive display voltage signal to the lowest voltage of the negative display voltage signal.

5. The driving control method of claim 1, wherein the voltage of the black-frame voltage signal is an average voltage of the greatest voltage and the lowest voltage of the source driver.

6. A source driver for a display device, the source driver comprising:
a first output buffer, for receiving a positive display voltage signal or a negative display voltage signal at a first input end and accordingly outputting a first source driving voltage signal to a first pixel;
a second output buffer, for receiving the positive display voltage signal or the negative display voltage signal at a second input end and accordingly outputting a second driving voltage signal to a second pixel;
a positive digital-analog converter, for outputting the positive display voltage signal at a positive output end according to a positive pixel data signal;
a negative digital-analog converter, for outputting the negative display voltage signal at a negative output end according to a negative pixel data signal;
a positive data switch, coupled to the positive output end and a first node;
a negative data switch, coupled to the negative output end and a second node;
a positive black-frame switch, coupled to the first node and a black-frame power, wherein the voltage of the black-frame power is a black-frame voltage;
a negative black-frame switch, coupled to the second node and the black-frame power;
a first flopping switch, coupled to the first node and the first output buffer;
a second flopping switch, coupled to the first node and the second output buffer;
a third flopping switch, coupled to the second node and the first output buffer; and
a fourth flopping switch, coupled to the second node and the second output buffer;
wherein the positive data switch, the first flopping switch, the negative data switch and the fourth flopping switch are conducted according to a first control signal, for allowing the positive digital-to-analog converter to output the positive display voltage signal to the first output buffer and allowing the negative digital-to-analog converter to output the negative display voltage signal to the second output buffer; and the positive black-frame switch and the negative black-frame switch are conducted according to a second control signal, for outputting the black-frame voltage signal to the first output buffer and the second output buffer.

7. The source driver of claim 6, wherein after outputting the black-frame voltage signal to the first output buffer and the second output buffer, the positive data switch, the second flopping switch, the negative data switch and the third flopping switch are conducted according to a third control signal, for allowing the positive digital-to-analog converter to output the positive display voltage signal to the second output buffer and allowing the negative digital-to-analog converter to output the negative display voltage signal to the first output buffer; and the positive black-frame switch and the negative black-frame switch are conducted according to a fourth control signal, for outputting the black-frame voltage signal to the first output buffer and the second output buffer.

8. The source driver of claim 6, wherein the voltage of the black-frame voltage signal is within a range from the greatest voltage of the positive display voltage signal to the lowest voltage of the negative display voltage signal.

9. The source driver of claim 6, wherein the voltage of the black-frame voltage signal is an average voltage of the greatest voltage and the lowest voltage of the source driver.

10. The source driver of claim 6, wherein the positive data switch, the negative data switch, the positive black-frame switch, the negative black-frame switch, the first flopping switch, the second flopping switch, the third flopping switch, and the fourth flopping switch are realized by transistors.
